(19) United States
(12) Patent Application Publication
(10) Pub. No.: US 2026/0196206 A1
(43) Pub. Date: Jul. 9, 2026

(54) CUSTOMER SERVICE PLAYBACK ASSISTANCE

(71) Applicant: Concentrix CVG Customer Management Delaware LLC, Cincinnati, OH (US)

(72) Inventors: Rattan Deep Singh, Kitchener, Ontario (CA); Gurmeet Singh, Charlotte, NC (US); John D. Bailey, Sorrento, FL (US); Kristin Joan Ranek, Ballwin, MO (US)

(21) Appl. No.: 19/129,689

(22) PCT Filed: Nov. 17, 2023
(86) PCT No.: PCT/US2023/080255

§ 371 Date: May 14, 2025

Related U.S. Application Data
(60) Provisional application No. 63/426,469, filed on Nov. 18, 2022.

(51) Int. Cl. G10L 13/027; H04M 3/51

(52) U.S. Cl. CPC G10L 13/027; H04M 3/5183

(57) ABSTRACT

A computing system is provided. The computing system includes a plurality of input/output devices; and a computing device. The computing device includes: a customer relationship management module; a text to speech module operable to obtain a text data input and provide an audio data output corresponding to the text data input; a computer audio input in operable communication with an agent audio input device to obtain the agent audio input; and a virtual audio cable module in operable communication with the computer audio input and the text to speech module, the virtual audio cable module configured to obtain the agent audio input from the agent audio input device and the audio data output from the text to speech module and generate a combined audio data output.

### CROSS-REFERENCE TO RELATED APPLICATIONS

This application claims the benefit of priority to PCT Application No. PCT/US2023/080255, filed Nov. 17, 2023, which claims priority to U.S. Provisional Application No. 62/426,469, filed Nov. 18, 2022. Each of these applications are hereby incorporated by reference in their entirety.

### FIELD

The present disclosure relates to a solution for assisting customer service agents convey information to end customers.

### BACKGROUND

Customer service agents are widely used to provide a variety of services to the end customers of a company. The customer service agents provide services in the fields of product support, billing, sales, and the like. Many of these customer services may be provided by a remote customer service agent via telephonic communication. In the process of providing one or more of these services, e.g., via telephone, at least certain customer service agents may be required to provide various disclosures, disclaimers, or the like to the end customer.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic view of a CRM tool in accordance with the present disclosure.

FIG. 2 is a schematic view of a text to speech module in accordance with the present disclosure.

FIG. 3 is a schematic view of a computing system in accordance with the present disclosure.

FIG. 4 is a flow diagram of a method for operating a computing system of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The term “at least one of” in the context of, e.g., “at least one of A, B, and C” refers to only A, only B, only C, or any combination of A, B, and C.

As noted above, in the process of providing one or more services to the end customer via telephone, at least certain customer service agents may be required to provide various disclosures, disclaimers, or the like to the end customer. Notably, the customer service agents may be employed by a third party engaged by the company to provide these customer services. Accordingly, in these cases, the company is the client of the customer service agents.

Failing to provide these disclosures, disclaimers, or the like to the end customer correctly may lead to misinformation to and misunderstandings of the end customer—which may lead to dissatisfaction of the end customer and the company/client—and may potentially lead to liabilities to the company/client. For example, failing to provide these disclosures, disclaimers, or the like to the end customer correctly may result in regulatory implications and penalties to the company/client.

In order to ensure these disclosures, disclaimers, or the like (referred to hereinbelow simply as “disclosures”) are provided in an exact manner to the end customer when the customer service agent is interacting with the customer via telephone, the inventors have found that it may be useful to automate a playback of the disclosure.

However, transferring the end customer from the agent with whom the customer is speaking (a “first agent”) to a new agent or other modality (e.g., a recording) to provide the disclosures creates a discontinuity of service, and if the customer has any questions or concerns regarding the disclosure, the first agent will not be able to answer the questions or address the concerns in real time.

Accordingly, the inventors of the present disclosure have discovered a solution that allows for the first agent to remain on the line with the customer while simultaneously providing automated disclosures to the customer, all without requiring modification of a customer relationship management software (or module) utilized by the agent.

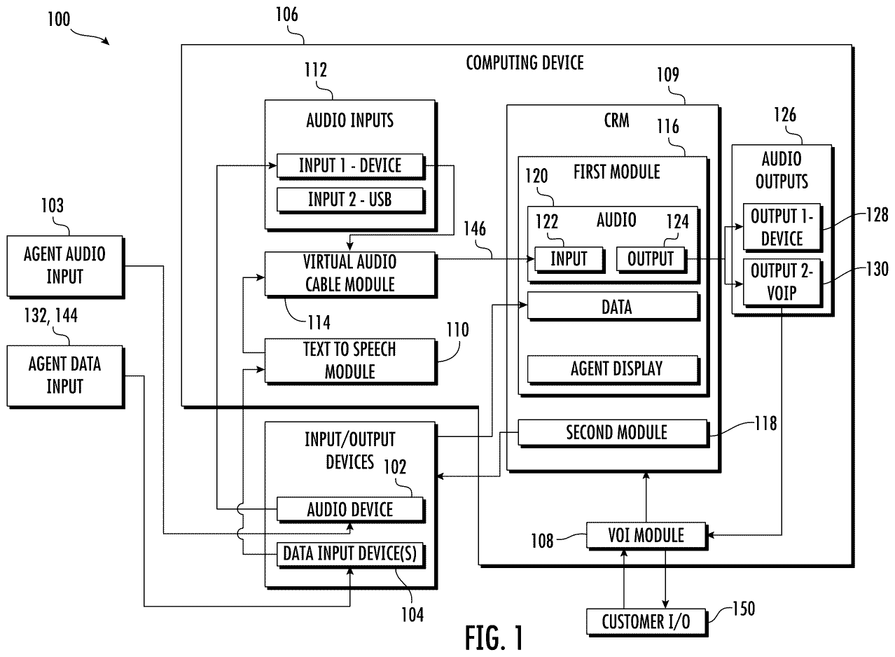

In particular, referring now to the drawings, FIG. 1 provides a schematic view of a computing system configured as a customer relationship management (CRM) tool 100 in accordance with an exemplary aspect of the present disclosure. The CRM tool 100 generally includes a plurality of input/output devices including an agent audio input device 102 configured to obtain an agent audio input 103 and an agent data input device 104 configured to obtain an agent data input. As used herein, the term “obtain” refers to any means by which data may be obtained (e.g., received directly or indirectly, accessed through intermediate memory, etc.).

The agent audio input device 102 may be any suitable device configured to send audio signals to a computer for, e.g., processing, recording, or carrying out commands. The agent audio input device 102 may include a microphone. The agent audio input 103 obtained by the agent audio input device 102 may be an agent's audio communication to be provided to an end customer.

The agent data input device 104 may be any suitable device configured to obtain data inputs from an agent and provide such data to a computer. The agent data input device 104 may include one or more of: a mouse, a keyboard, a touchpad, an audio input device (e.g., for voice commands), a camera, or the like. The agent data input may be text, command data, voice commands, etc. to be used drive operation of the CRM tool 100.

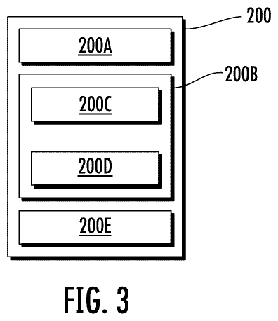

The CRM tool 100 further includes a computing device 106. The computing device 106 may generally have one or more processors and data, the data storing instruction that when executed by the one or more processors cause the computing device 106 to perform operations. Additional details of a computing device 106 in accordance with the present disclosure are provided below with reference to FIG. 3.

The computing device 106 includes: a voice over internet protocol (VOIP) module 108; a customer relationship management (CRM) module 109; a text to speech (TTS) module 110; a computer audio input 112; and a virtual audio cable (VAC) module 114. Each of these aspects will be described in more detail below. As will be appreciated, in certain exemplary aspects, such as the exemplary aspect depicted in FIG. 1, each of these modules may be separate from the other modules. Note that in FIG. 1, flow lines are provided to show the transfer of data from one module/aspect of the CRM tool 100 to another module/aspect of the CRM tool 100.

Moreover, as used herein, the term “module” generally refers to a distinct functional unit or component within the computing device 106 that is designed to perform a specific operation or set of operations. The module(s) may be either software-based, hardware-based, or a combination of both. Software-based modules could be different programs or sets of code, while hardware-based modules could be physical components like sensors or circuits.

The VOIP module 108 is configured to allow a customer service agent (or simply “agent”) to make voice calls with an end customer through a broadband internet connection instead of an analog phone line. The VOIP module 108 is configured to both receive audio inputs from the end customer and provide audio outputs to the end customer. In such a manner, the VOIP module 108 allows for the agent to have a conversation with the end customer to address any customer service needs of the end customer.

The CRM module 109 is a system that helps a business keep track of various aspects of their relationships with their customers. The CRM module 109 may store customer data of customers, such as the customers' contact information and other identity information, descriptive data (e.g., career and education details, family details, lifestyle details), quantitative data (e.g., purchase history, frequency of site visits), and qualitative data (e.g., reviews of the company). The CRM module 109 may also store customer service history data.

The CRM module 109 may be utilized for a variety of customer service functionalities, such as sales, product support, and billing support. The CRM module 109 of the CRM tool 100 depicted includes a plurality of modules to support these different functionalities. A first module 116 may support a first functionality, a second module 118 may support a second functionality, etc.

With reference to the first module 116, the first module 116 of the CRM module 109 includes an audio module 120 having an audio input 122 and an audio output 124. The audio input 122 may obtain audio data from the VOIP module 108 (e.g., the end customer's voice input) and an input from the VAC module 114 (which, as will be explained in more detail below, may be a combined audio data output). The audio output 124 is configured to provide an audio output signal to a computer audio output 126. As will be appreciated from the description herein, the audio output signal may correspond to the audio data from the VOIP module 108, the input from the VAC module 114, or both.

The computer audio output 126 includes a first output device 128, which may be an agent audio output device of the agent, and in some instances may be the same device as the agent audio input device 102. The computer audio output 126 further includes a second output device 130, which is connected to the VOIP module 108. In such a manner, the audio module 120 may facilitate audio communications between the agent and the customer using the VOIP module 108, mimicking a traditional telephone call.

Notably, although in the embodiment depicted the VOIP module 108 is depicted as being a separate module from the CRM module 109, in other embodiments, the CRM module 109 may incorporate the VOIP module 108, such that the audio output 124 from the audio module 120 is provided directly to the VOIP module 108 and the audio input 122 of the audio module 120 is configured to obtain end customer audio direction from the VOIP module 108.

With such a configuration, the VOIP module 108 may be configured as part of the first module 116 of the CRM module 109. Also, as will be explained further, below, in at least certain exemplary aspects, the computer audio output 126 may be the same as the computer audio input 112, such that the agent audio input device 102 is the same as the agent audio output device 128.

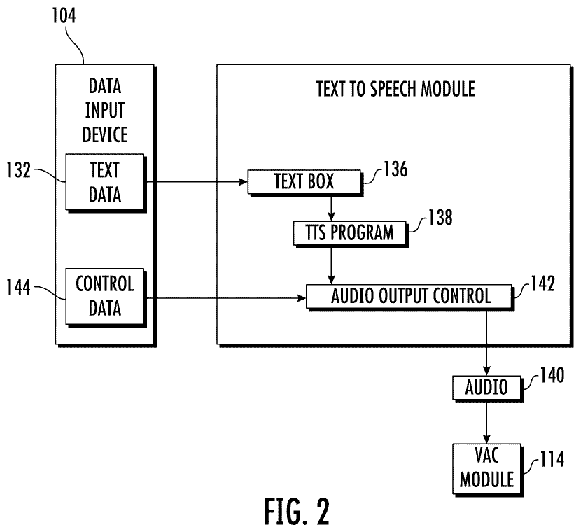

The TTS module 110 is operable to obtain a text data input 132 and provide an audio data output (indicated by data transfer line 134 in FIG. 1) corresponding to the text data input 132. In particular, referring also to FIG. 2, providing a schematic view of a TTS module 110 in accordance with one embodiment, the TTS module 110 is configured to obtain the text data input 132 form or using, e.g., the agent data input device 104. The TTS module 110 may be configured to display a text box 136 on a peripheral of the computing device 106, such as a display (e.g., on the agent's computer screen or other display device). The agent, using one or more data input devices 104 may provide text data input 132 into the text box 136 of the TTS module 110. The text data input 132 may be copied from a readout of the CRM module 109, or may be copied from another program on the computing device 106 (e.g., an email program). The text data input 132 may correspond to a disclosure, a disclaimer, or the like that the agent is requested to provide to the end customer.

For example, the text data input 132 may be copied using the computing device 106 based on an input from the agent data input device 104 (e.g., the agent data input device 104 may be a mouse and/or other similar peripheral that selects text data from a separate module from the TTS module 110 and commands the selected text data to be copied by the computing device 106). The copied text data input 132 may then be pasted into the text box 136 based on another input from the agent data input device 104 (e.g., the agent data input device 104 may again be a mouse and/or other similar peripheral that commands the copied text data to be pasted into the text box 136 by the computing device 106).

The TTS module 110 may provide the text from the text box 136 to a TTS program 338 that may generate the audio data output 140 corresponding to the text from the text box 136. An audio output control 142 may provide the audio data output 140 to the VAC module 114. The audio output control 142 may obtain control data 144 from the agent through the agent input device. The control data may include playback data, such as one or more of “start”, “stop”, “pause”, “rewind”, “fast forward”, “skip forward”, “skip back”, etc. In such a manner, the TTS module 110 may allow the agent to control the playback of the audio data output 140 to the VAC module 114 using an agent data input device 104.

Referring back specifically to FIG. 1, the computer audio input 112 is in operable communication with the agent audio input device 102 to obtain the agent audio input 103. The computer audio input 112 may be a first audio input of a plurality of audio inputs of the computing device 106.

The VAC module 114 is in operable communication with the computer audio input 112 and the TTS module 110. The VAC module 114 is configured to obtain the agent audio input 103 from the agent audio input device 102 and the audio data output (indicated at line 134) from the TTS module 110 and generate a combined audio data output (indicated at line 146).

In at least certain exemplary aspects, the VAC module 114 is an audio bridge between applications that transmits sounds (audio streams) from application/module to application/module. The VAC module 114 may create a set of virtual audio devices, in a manner that will be appreciated to generate the combined audio data output indicated at line 146.

The audio input 122 of the CRM module 109 is operably connected to the VAC module 114 to obtain the combined audio data output as an agent audio data input of the CRM module 109. The agent audio data input of the CRM module 109 may traditionally be configured to obtain an agent audio input directly for the computer audio input 112.

In such a manner, the CRM module 109 only sees a single audio input, and more specifically, the CRM module 109 only receives a single audio input (i.e., the combined audio data output indicated at line 146 from the VAC module 114). Such will allow for the functionality described herein to be achieved without any modification or without significant modification of the CRM module 109.

More specifically, during operation, the agent may have a telephonic conversation with the end customer. The agent may speak into the audio input device 102, and may hear the customer through the audio output device 128 (which may be the same device as the audio input device). The VOIP module 108 may be used to communicate agent audio input 103 and audio input data of the agent obtained from the audio input device 102 to the end customer, and may provide customer audio input (provided through a customer input/output device(s) 150) to the agent through the audio output device 128. More specifically, the VOIP module 108 may be used to communicate the combined audio data output (indicated by line 146; generated with the VAC module 114) to the end customer.

During the course of the conversation, it may be necessary for the agent to provide the end customer with a disclosure, disclaimer, or the like (collectively a “disclosure”). The disclosure may be relatively long in nature (e.g., at least 25 words, such as at least 100 words, and up to 3,000 words or more in some embodiments) and it may be important that the disclosure is provided accurately to the end customer. The CRM tool 100 described herein may allow for the agent to insert text data corresponding to the disclosure into the text box 136 of the TTS module 110, and allow the TTS module 110 to “read” the disclosure to the end customer (through translation of the text provided to the text box 136 into an audio output 140 by the TTS program 138, and controlled by the agent using the audio output control 142).

Notably, through incorporation of the VAC module 114, separately from the CRM module 109, the CRM tool 100 may allow for the agent to continue the call with the end customer (i.e., remain on the line with the end customer) and correspond directly with the end customer while the TTS module 110 reads the disclosure to the end customer. Through use of the VAC module 114, the agent's voice and the audio output 140 from the TTS module 110 are provided to the CRM module 109 (and more specifically to the audio input 122) as a single audio signal. The agent may stop or pause the TTS module playback (through the audio output control 142) to facilitate the simultaneous conversation with the end customer. In such a manner, the agent may be available to answer any questions of the end customer, offer explanations, etc., and may generally provide a more seamless customer service experience.

The playback functionalities of the TTS module 110 may allow the agent to pause or stop the playback to answer customer questions and otherwise provide commentary on the disclosure being read.

Further, through incorporation of the VAC module 114, separately from the CRM module 109, the above functionality may be provided without any modifications being necessary to the CRM module 109.

Through use of the TTS module 110 to read the disclosure, the agent may use the most up-to-date disclosure text, which may be provided to the agent through the CRM module 109, or through a computer program separate from the CRM module 109, such as through email or a web-based source separate from the CRM module 109. The present configuration does not require any pre-recording of the message.

It will be appreciated that the exemplary embodiment depicted in FIG. 1 is by way of example only. In other embodiments the CRM tool 100 may be configured in any other suitable manner. For example, as noted above, the VOIP module 108 may be incorporated into the CRM module 109. Additionally, or alternatively, although the computing device 106 depicted shows separate Audio Inputs and Audio Outputs, in other embodiments, the computing device 106 may include one or more combined audio inputs/outputs.

The various modules depicted and described above may generally include a set of computer readable instructions stored in memory of a computing device 106, that when executed by one or more processors of the computing device 106, cause the computing device 106 to perform operations. A sample computing device 106 is depicted in FIG. 3, and described below.

As noted, in one or more exemplary embodiments, the computing device of FIG. 1 may be configured in a similar manner as the computing device(s) 200. The computing device(s) 200 can include one or more processor(s) 200A and one or more memory device(s) 200B. The one or more processor(s) 200A can include any suitable processing device, such as a microprocessor, microcontroller, integrated circuit, logic device, and/or other suitable processing device. The one or more memory device(s) 200B can include one or more computer-readable media, including, but not limited to, non-transitory computer-readable media, RAM, ROM, hard drives, flash drives, and/or other memory devices.

The one or more memory device(s) 200B can store information accessible by the one or more processor(s) 200A, including computer-readable instructions 200C that can be executed by the one or more processor(s) 200A. The instructions 200C can be any set of instructions that when executed by the one or more processor(s) 200A, cause the one or more processor(s) 200A to perform operations. In some embodiments, the instructions 200C can be executed by the one or more processor(s) 200A to cause the one or more processor(s) 200A to perform operations, such as any of the operations and functions for which the computing device is configured, and/or any other operations or functions of the one or more computing device(s) 200.

The instructions 200C can be software written in any suitable programming language or can be implemented in hardware. Additionally, and/or alternatively, the instructions 200C can be executed in logically and/or virtually separate threads on the one or more processor(s) 200A. The one or more memory device(s) 200B can further store data 200D that can be accessed by the one or more processor(s) 200A.

The computing device(s) 200 can also include a network interface 200E. The network interface 200E can include any suitable components for interfacing with one or more network(s), such as the internet, an intranet, a local area network, or the like. The network interface 200E may include, for example, transmitters, receivers, ports, controllers, antennas, and/or other suitable components.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

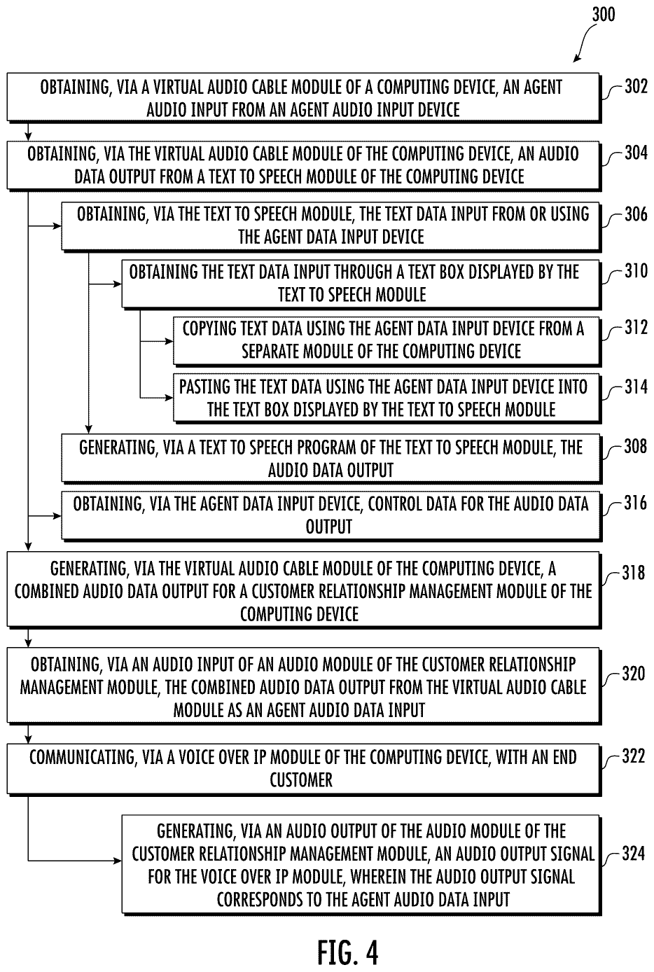

Referring now to FIG. 4, a flow diagram of a method 300 of operating a computing system in accordance with an exemplary aspect of the present disclosure is provided. The method 300 may be used with one or more of the exemplary embodiments discussed above with reference to FIGS. 1 through 3.

Alternatively, the method 300 may be used with one or more of the alternative exemplary embodiments.

The method 300 includes at (302) obtaining, via a virtual audio cable module of a computing device, an agent audio input from an agent audio input device. Obtaining the agent audio input at (302) may include obtaining an audio input from an agent through the agent audio input device. As used herein, the term “obtaining” refers generally to any means by which data may be obtained (e.g., received directly or indirectly, accessed through intermediate memory, etc.).

The method 300 further includes at (304) obtaining, via the virtual audio cable module of the computing device, an audio data output from a text to speech module of the computing device. The audio data output corresponds to a text data input obtained by the text to speech module from or using an agent data input device. For example, in the embodiment FIG. 4, obtaining the audio data output from the text to speech module of the computing device at (304) includes at (306) obtaining, via the text to speech module, the text data input from or using the agent data input device; and at (308) generating, via a text to speech program of the text to speech module, the audio data output.

In particular, in one exemplary embodiment, obtaining, via the text to speech module, the text data input from or using the agent data input device at (306) includes at (310) obtaining the text data input through a text box displayed by the text to speech module. In one exemplary embodiment, obtaining the text data input through the text box displayed by the text to speech module at (310) includes: at (312) copying text data using the agent data input device from a separate module of the computing device; and at (314) pasting the text data using the agent data input device into the text box displayed by the text to speech module. The separate module may be an email module (e.g., a software module such as Microsoft Outlook™, an internet module such as GMail™, or the like) or a text editing module (e.g., Microsoft Word™, or the like).

Referring still to FIG. 4, in the exemplary embodiment depicted, it will further be appreciated that obtaining the audio data output from the text to speech module of the computing device at (304) includes at (316) obtaining, via the agent data input device, control data for the audio data output. The control data may include playback data. The playback data corresponds to one or more of the following commands: “start”, “stop”, “pause”, “rewind”, “fast forward”, “skip forward”, “skip back”.

Referring still to FIG. 4, the method 300 includes at (318) generating, via the virtual audio cable module of the computing device, a combined audio data output for a customer relationship management module of the computing device, the combined audio data output being a combination of the obtained agent audio input and the obtained audio data output. Moreover, for the exemplary embodiment of FIG. 4, the method 300 further includes at (320) obtaining, via an audio input of an audio module of the customer relationship management module, the combined audio data output from the virtual audio cable module as an agent audio data input; and at (322) communicating, via a voice over IP module of the computing device, with an end customer. In particular, communicating, via the voice over IP module of the computing device, with the end customer using at (322) includes at (324) generating, via an audio output of the audio module of the customer relationship management module, an audio output signal for the voice over IP module, wherein the audio output signal corresponds to the agent audio data input.

The exemplary method 300 of FIG. 4 may therefore allow the agent to communicate disclaimers or disclosure in text form with the customer without having to transfer the customer to a separate individual or a separate TTS module integrated into the CRM module, allowing the agent to remain on the line as the disclaimer or disclosures are being read by a separate TTS module and discuss the disclaimers or disclosures with the customer in real time. In particular, through incorporation of the VAC module, separately from the CRM module, the CRM tool may allow for the agent to continue the call with the end customer (i.e., remain on the line with the customer) and correspond directly with the end customer while the TTS module reads the disclosure to the end customer. Through use of the VAC module 114, the agent's voice and the audio output from the TTS module are provided to the CRM module (and more specifically to the audio input) as a single audio signal. The agent may stop or pause the TTS module playback (through the audio output control) to facilitate the simultaneous conversation with the end customer. In such a manner, the agent may be available to answer any questions of the end customer, offer explanations, etc., and may generally provide a more seamless customer service experience.

The playback functionalities of the TTS module may allow the agent to pause or stop the playback to answer customer questions and otherwise provide commentary on the disclosure being read.

Further, through incorporation of the VAC module, separately from the CRM module, the above functionality may be provided without any modifications being necessary to the CRM module.

Through use of the TTS module to read the disclosure, the agent may use the most up-to-date disclosure text, which may be provided to the agent through the CRM module, or through a computer program separate from the CRM module, such as through email or a web-based source separate from the CRM module. The present method does not require any pre-recording of the message.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

We claim:

1. A computing system comprising:
a plurality of input/output devices comprising an agent audio input device configured to obtain an agent audio input and an agent data input device configured to obtain an agent data input; and
a computing device, the computing device comprising
a customer relationship management module;
a text to speech module operable to obtain a text data input and provide an audio data output corresponding to the text data input, wherein the text data input is obtained from or using the agent data input device;
a computer audio input in operable communication with the agent audio input device to obtain the agent audio input; and
a virtual audio cable module in operable communication with the computer audio input and the text to speech module, the virtual audio cable module configured to obtain the agent audio input from the agent audio input device and the audio data output from the text to speech module and generate a combined audio data output;
wherein the customer relationship management module comprises an audio input operably connected to the virtual audio cable module to obtain the combined audio data output as an agent audio data input.

2. The computing system of claim 1, wherein the computing device further comprises a voice over IP module configured to communicate the agent audio data input to an end customer.

3. The computing system of claim 1, wherein the text to speech module is configured to display a text box on a peripheral of the computing device.

4. The computing system of claim 3, wherein the text to speech module is configured to obtain the text data input from or using the agent data input device.

5. The computing system of claim 4, wherein the text data input corresponds to a disclosure, a disclaimer, or a combination thereof to be provided to an end customer.

6. The computing system of claim 3, wherein the text to speech module comprises a TTS program operable to generate the audio data output corresponding to the text data input obtained through the text box.

7. The computing system of claim 1, wherein the text to speech module comprises an audio output control in communication with the agent data input device to obtain control data from the agent.

8. The computing system of claim 7, wherein the control data includes playback data, wherein the playback data corresponds to one or more of the following commands: “start”, “stop”, “pause”, “rewind”, “fast forward”, “skip forward”, “skip back”.

9. The computing system of claim 1, wherein the virtual audio cable module is separate from the customer relationship management module.

10. The computing system of claim 1, wherein the customer relationship management module comprises an audio module having the audio input configured to obtain an audio signal from a single audio source.

11. A method of operating a computing system, the method comprising:
obtaining, via a virtual audio cable module of a computing device, an agent audio input from an agent audio input device;
obtaining, via the virtual audio cable module of the computing device, an audio data output from a text to speech module of the computing device, wherein the audio data output corresponds to a text data input obtained by the text to speech module from or using an agent data input device; and
generating, via the virtual audio cable module of the computing device, a combined audio data output for a customer relationship management module of the computing device, the combined audio data output being a combination of the obtained agent audio input and the obtained audio data output.

12. The method of claim 11, wherein obtaining the audio data output from the text to speech module of the computing device with the virtual audio cable module of the computing device comprises:
obtaining, via the text to speech module, the text data input from or using the agent data input device; and
generating, via a text to speech program of the text to speech module, the audio data output.

13. The method of claim 11, wherein obtaining, via the text to speech module, the text data input from or using the agent data input device comprises obtaining the text data input through a text box displayed by the text to speech module.

14. The method of claim 13, wherein obtaining the text data input through the text box displayed by the text to speech module comprises:
copying text data using the agent data input device from a separate module of the computing device; and
pasting the text data using the agent data input device into the text box displayed by the text to speech module.

15. The method of claim 14, wherein the separate module is an email module or a text editing module.

16. The method of claim 11, wherein obtaining, via the virtual audio cable module of the computing device, the audio data output from the text to speech module of the computing device comprises:
obtaining, via the agent data input device, control data for the audio data output.

17. The method of claim 16, wherein the control data includes playback data, wherein the playback data corresponds to one or more of a group of commands, the group of commands including: “start”, “stop”, “pause”, “rewind”, “fast forward”, “skip forward”, “skip back”.

18. The method of claim 11, wherein the virtual audio cable module is separate from the customer relationship management module.

19. The method of claim 11, further comprising:
obtaining, via an audio input of an audio module of the customer relationship management module, the combined audio data output from the virtual audio cable module as an agent audio data input.

20. The method of claim 19, further comprising:
communicating, via a voice over IP module of the computing device, with an end customer, wherein communicating, via the voice over IP module of the computing device, with the end customer using comprises:
generating, via an audio output of the audio module of the customer relationship management module, an audio output signal for the voice over IP module, wherein the audio output signal corresponds to the agent audio data input.
